(19) United States
(12) Patent Application Publication
(10) Pub. No.: US 2017/0297326 A1
(43) Pub. Date: Oct. 19, 2017

(54) INKJET HEAD AND INKJET PRINTER

(71) Applicant: TOSHIBA TEC KABUSHIKI KAISHA, Tokyo (JP)

(72) Inventor: Ryuta Nagane, Sunto Shizuoka (JP)

(21) Appl. No.: 15/447,228

(22) Filed: Mar. 2, 2017

(30) Foreign Application Priority Data
Apr. 13, 2016 (JP) 2016-080398

(51) Int. Cl. B41J 2/045

(52) U.S. Cl. CPC B41J 2/04536; B41J 2/04586

(57) ABSTRACT

In accordance with an embodiment, an inkjet head comprises a counter, a plurality of comparators, a head drive signal generation section and a head main body. The counter counts a count value at a predetermined interval. The plurality of the comparators sets a comparative value obtained from the count value and an offset value if a first transmission start signal is input from a first device, and outputs a second transmission start signal to a second device if the count value becomes the comparative value. The head drive signal generation section outputs a head drive signal if the second transmission start signal is input. The head main body ejects an ink to a print medium if the head drive signal is input.

### CROSS-REFERENCE TO RELATED APPLICATIONS

This application is based upon and claims the benefit of priority from Japanese Patent Application No. P2016-080398, filed Apr. 13, 2016, the entire contents of which are incorporated herein by reference.

### FIELD

Embodiments described herein relate generally to an inkjet head, an inkjet printer, and methods associated therewith.

### BACKGROUND

There is an inkjet printer for ejecting an ink to the same area of a print medium from a plurality of inkjet heads to form an image. The inkjet printer ejects the ink to the print medium from each inkjet head arranged in a row in a movement direction while moving the print medium. The inkjet head ejects the ink after a predetermined offset time elapses from a moment a transmission start signal indicating that the print medium is detected or a previous transmission start signal of the inkjet head is received in order to match an ejection timing.

However, in cases where the width of the formed image is smaller than an interval between the inkjet heads, the inkjet head receives a next transmission start signal while waiting for lapse of the offset time from a moment the transmission start signal is received. If the next transmission start signal is received during the offset time, the inkjet printer cannot form the image at the desired time.

### DESCRIPTION OF THE DRAWINGS

FIG. 1 is a diagram exemplifying the constitution of an inkjet printer according to an embodiment;

FIG. 2 is a block diagram exemplifying the constitution of the inkjet printer according to the embodiment;

FIG. 3 is a block diagram exemplifying the constitution of a control board according to the embodiment;

FIG. 4 is a diagram illustrating an example of the operation of the control board according to the embodiment; and

FIG. 5 is a diagram illustrating an example of the operation of the inkjet printer according to the embodiment.

### DETAILED DESCRIPTION

In accordance with an embodiment, an inkjet head comprises a counter, a plurality of comparators, a head drive signal generation section and a head main body. The counter counts a count value at a predetermined interval. The plurality of the comparators sets a comparative value obtained from the count value and an offset value if a first transmission start signal is input from a first device, and outputs a second transmission start signal to a second device if the count value becomes the comparative value. The head drive signal generation section outputs a head drive signal if the second transmission start signal is input. The head main body ejects an ink to a print medium if the head drive signal is input.

Hereinafter, an embodiment is described with reference to the accompanying drawings.

An inkjet printer according to the embodiment ejects an ink stored in an ink cartridge to a print medium (for example, paper) to form an image on a print medium. The inkjet printer includes a plurality of inkjet heads. The inkjet head ejects the ink to the same area of the print medium from each inkjet head to form the image.

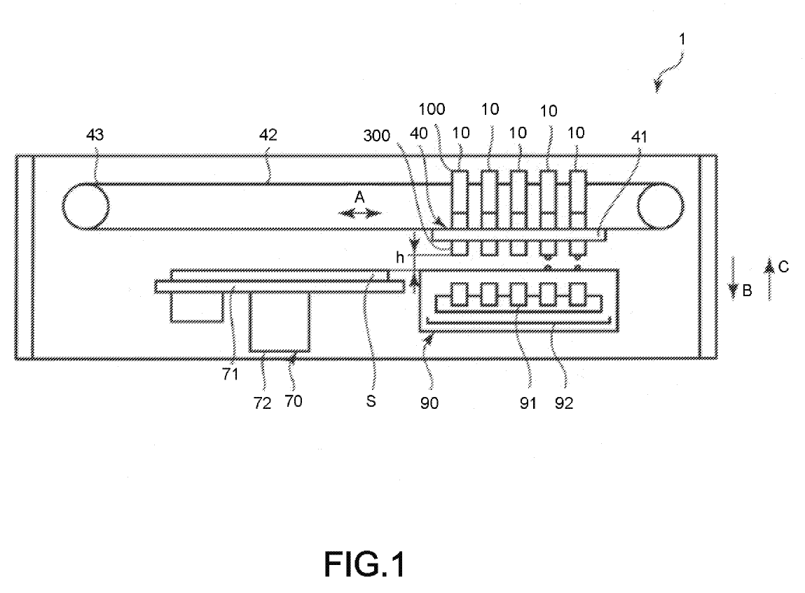

FIG. 1 is a diagram exemplifying the constitution of an inkjet printer 1. The inkjet printer 1 comprises a plurality of inkjet head units 10 (10a to 10e) and ink cartridges respectively corresponding to the plurality of the inkjet head units 10. The inkjet printer 1 comprises a head support section 40, a print medium movement section 70 and a maintenance unit 90. The head support section 40 movably supports a plurality of the inkjet head units 10. The print medium movement section 70 moveably supports a print medium S. The inkjet printer 1 includes a detection section 110 described later and an encoder 120.

The inkjet head unit 10 includes an inkjet head 300 which is a liquid ejection section and an ink circulation device 100 for circulating the ink.

The ink cartridge of each color communicates with the ink circulation device 100 of the corresponding inkjet head unit 10 via a tube. Each ink cartridge supplies the ink to each inkjet head unit 10.

The colors of the ink in the inkjet head units 10 may be different from each other. For example, the color of the ink is cyan, magenta, yellow or black.

The head support section 40 conveys the inkjet head unit 10 to a predetermined position to fix it. For example, the head support section 40 comprises a cartridge 41, a conveyance belt 42 and a cartridge motor 43. The cartridge 41 supports a plurality of the inkjet head units 10. The conveyance belt 42 reciprocates the cartridge 41 in an arrow A direction. The cartridge motor 43 drives the conveyance belt.

The print medium movement section 70 (conveyance section) conveys the print medium S in a predetermined conveyance path. For example, the print medium movement section 70 has a table 71 for absorbing the print medium S to fix it. The table 71 is mounted on a slide rail device 72 to reciprocate in a direction (a direction orthogonal to surface of FIG. 1) orthogonal to the arrow A direction and an arrow B direction. In other words, the print medium movement section 70 reciprocates the table 71 in a direction orthogonal to the cartridge 41.

The maintenance unit 90 is arranged at a position beyond a movement range of the table 71 which is a scanning range of the plurality of the inkjet head units 10 in the arrow A direction. The maintenance unit 90 is a case with an upper side thereof opened and is movably arranged in a vertical direction (the arrow B direction and an arrow C direction in FIG. 1).

The maintenance unit 90 includes a blade 91 made of rubber and a waste ink receiving section 92. The blade 91 removes the ink, dust or paper powder attached to a nozzle plate of the inkjet head 300 of the inkjet head unit 10 of each color. The waste ink receiving section 92 receives the ink, the dust or the paper powder removed by the blade 91. The maintenance unit 90 includes a mechanism for moving the blade 91 in a direction orthogonal to the arrow A direction and the arrow B direction. The blade 91 wipes the surface of the nozzle plate.

Next, an example of the constitution of the inkjet head 300 is described.

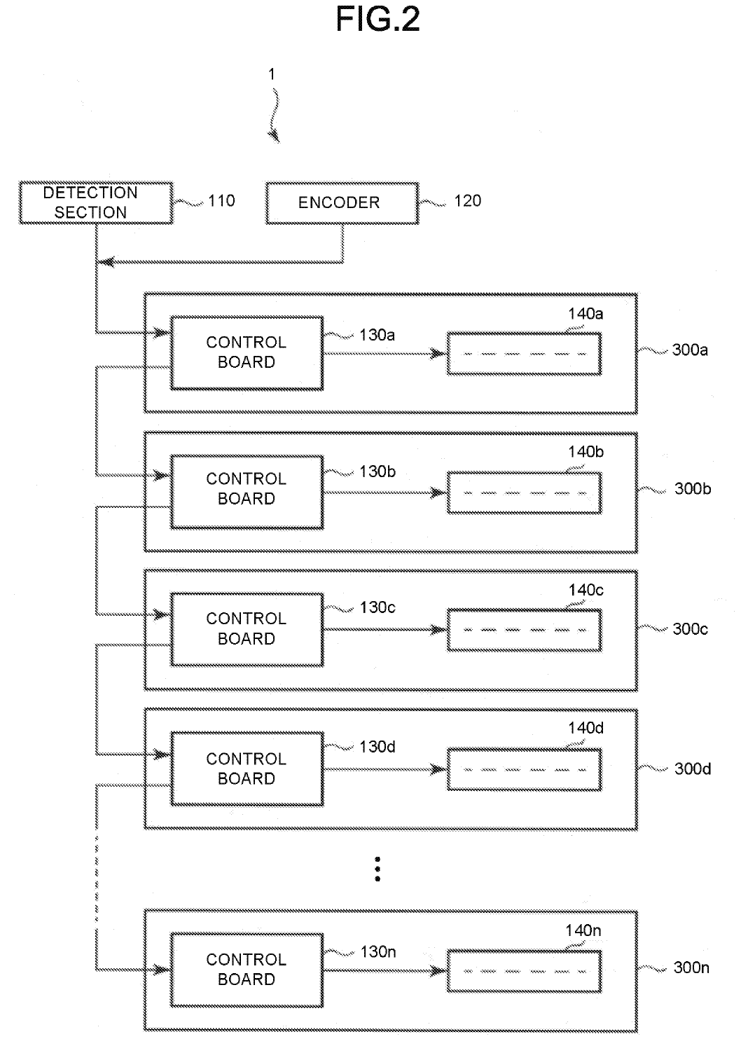

FIG. 2 is a block diagram exemplifying the constitution of each inkjet head 300.

As shown in FIG. 2, the inkjet printer 1 includes a plurality of the inkjet heads 300, a detection section 110 and the encoder 120. Herein, the inkjet printer 1 is provided with inkjet heads 300a to 300n. The inkjet printer 1 may include a plurality of the inkjet heads 300. The number of the inkjet heads 300 provided in the inkjet printer 1 is not limited to a specific number.

The inkjet heads 300 (300a to 300n) are provided with control boards 130 (130a to 130n) and printing sections 140 (140a to 140n). The inkjet heads 300a to 300n are respectively provided with the control boards 130a to 130n and the printing sections 140a to 140n.

The control board 130 outputs a head drive signal for ejecting the ink to the printing section 140.

The control board 130a is connected with the detection section 110 and the encoder 120 in a communicable manner. The control board 130 is connected with the control board 130 (the control board 130 of the inkjet head 300 for ejecting the ink next) of a next stage via a cascade connection. For example, the control board 130a is connected with the control board 130b. The control board 130b is connected with the control board 130c.

The example of the constitution of the control board 130 is described in detail later.

The printing section 140 (head main body) ejects the ink to the print medium S based on the print data from a host device.

The printing section 140 operates according to the head drive signal from the control board 130. In other words, the printing section 140 starts an ejection operation based on the head drive signal if receiving the head drive signal from the control board 130.

For example, the printing section 140 includes an ink chamber for storing the ink and a drive circuit for driving a wall surface of the ink chamber. The drive circuit applies a voltage to the ink chamber so as to form a predetermined image according to the head drive signal. The wall surface of the ink chamber is formed by a piezoelectric element to operate according to a drive voltage output by the drive circuit. By the drive of the wall surface, a volume of the inside of the ink chamber changes. The printing section 140 ejects the ink stored therein to the print medium S from an ejection hole by changing the volume of the ink chamber.

The printing sections 140a to 140n are arranged to eject the ink to the same area of the print medium S. The printing sections 140a to 140n are arranged so as to be orthogonal to a direction (conveyance direction) in which the print medium S is conveyed and an arrangement direction of the ejection holes. The printing sections 140a to 140n are arranged in order by a predetermined width in the conveyance direction. For example, the print medium S passes through the ejection holes of the printing section 140a, the printing section 140b, . . . and the printing section 140n in order.

It is defined that the print medium S is conveyed from an upstream side to a downstream side.

The detection section 110 is arranged on the conveyance path of the print medium S. The detection section 110 detects that the print medium S is conveyed to a predetermined position where the printing is started. For example, the detection section 110 detects that the print medium S is conveyed to a predetermined position at the upstream side of the printing section 140a.

The detection section 110 is constituted by, for example, an optical sensor. The detection section 110 may detect a marker on the print medium S. The detection section 110 may detect a front end of the print medium S.

The detection section 110 transmits the transmission start signal indicating that the printing is started to the control board 130a of the inkjet head 300a if the print medium S is detected.

The encoder 120 outputs a movement pulse in response to a movement amount of the print medium S. The encoder 120 transmits the movement pulse to the control board 130a of the inkjet head 300a. Further, the movement pulse is supplied to the control board 130 of the next stage at any time.

The control board 130 is described.

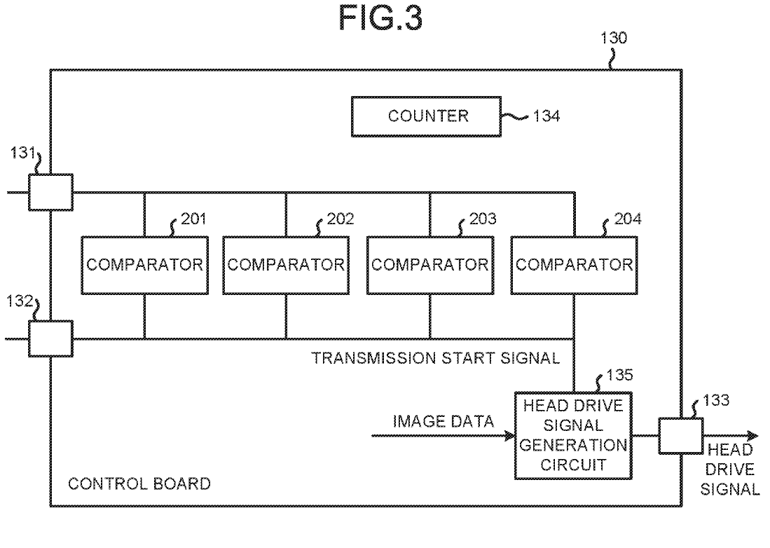

FIG. 3 is a block diagram exemplifying the constitution of the control board 130a. As shown in FIG. 3, the control board 130 includes communication sections 131 to 133, a counter 134, a head drive signal generation circuit 135 and comparators 201 to 204.

The communication section 131 is an interface for communicating with the control board 130 of the upper stage (the control board 130 of the inkjet head 300 for ejecting the ink previously) (a first device) or the detection section 110 (second device). The communication section 131 may communicate with the encoder 120. For example, the communication section 131 receives the transmission start signal from the control board 130 of the upper stage or the detection section 110. The communication section 131 outputs the received transmission start signal to the comparators 201 to 204.

The communication section 132 is an interface for communicating with the control board 130 (second device) of the lower stage. The communication section 132 outputs the transmission start signal output by any one of the comparators 201 to 204 to the control board 130 of the lower stage.

The communication section 133 is an interface for communicating with the printing section 140. The communication section 133 outputs the head drive signal output by the head drive signal generation circuit 135 to the printing section 140.

The counter 134 counts up the count value at a predetermined interval. For example, the counter 134 counts up the count value based on a clock signal generated therein. The counter 134 counts up the count value if counting the clock signal a predetermined number of times.

The counter 134 may count up the count value based on the movement pulse. For example, the counter 134 counts up the count value if the clock signal is received for the predetermined number of times via the communication section 132.

The counter 134 returns the count value to an initial count value (for example, “0”) if the count value is overflowed. Herein, the counter 134 can count the count value from “0” to “999”. Thus, the counter 134 returns the count value to “0” if the count value is counted up in a case in which the count value is “999”.

The counter 134 may set the count value to “0” according to a reset signal from an external device.

The comparator 201 sets a value (comparative value) obtained by adding a predetermined offset value (OF) to the count value by the counter 134 therein at a time point the transmission start signal is received if the transmission start signal (first transmission start signal) is received (input) via the communication section 131. For example, the comparator 201 stores the comparative value in a memory provided therein.

The offset value corresponds to a standby time until the printing is started from a moment the transmission start signal is received. In other words, the offset value is obtained by counting up the count value by the counter 134 at the standby time. For example, in the control board 130a, an offset value a is obtained by counting a time with the counter 134 which is required to move the print medium S from a position where the detection section 110 detects the print medium S to a position where the printing section 140a can carry out printing on a predetermined position of the print medium S. In the control boards 130b to 130n, the offset values b to n are obtained by counting the time with the counter 134 which is, required to move the print medium S by a distance between the printing sections 140. In other words, the offset values b to n are values corresponding to the time required to convey the print medium S by a distance between the printing section 140 and the adjacent printing section 140.

The comparator 201 previously stores the offset value in the memory therein. The offset value may be stored at the time of manufacture, or may be properly updated.

The comparator 201 sets an overflowed value as the comparative value in a case in which the comparative value exceeds an upper limit (for example, “999”) of the count value by the counter 134. For example, in a case in which the comparative value is “1010”, the comparator sets “10” (1010-1000) as the comparative value.

The comparator 201 outputs the transmission start signal (second transmission start signal) if the count value by the counter 134 is coincident with the comparative value. For example, the comparator 201 acquires the count value by the counter 134 at any time to determine whether or not the acquired count value is coincident with the comparative value.

The comparator 201 outputs the transmission start signal via the communication section 132 to the control board 130 of the next stage if the count value by the counter 134 is coincident with the comparative value. The comparator 201 outputs the transmission start signal to the head drive signal generation circuit 135 if the count value by the counter 134 is coincident with the comparative value.

The comparators 202 to 204 have the same constitution as the comparator 201.

The control board 130 is provided with four comparators 201 to 204. Furthermore, the control board 130 may include a plurality of the comparators, and the number of the comparators included in the control board 130 is not limited to a specific number.

The head drive signal generation circuit 135 (head drive signal generation section) generates the head drive signal to send the generated head drive signal to the printing section 140 via the communication section 133. The head drive signal generation circuit 135 receives the print data for forming an image on the print medium S. The head drive signal generation circuit 135 generates the head drive signal based on the print data. The head drive signal generation circuit 135 sends the head drive signal to the printing section 140 via the communication section 133 if the transmission start signal is received from any one of the comparators 201 to 204.

Next, an example of the operation of the control board 130 is described.

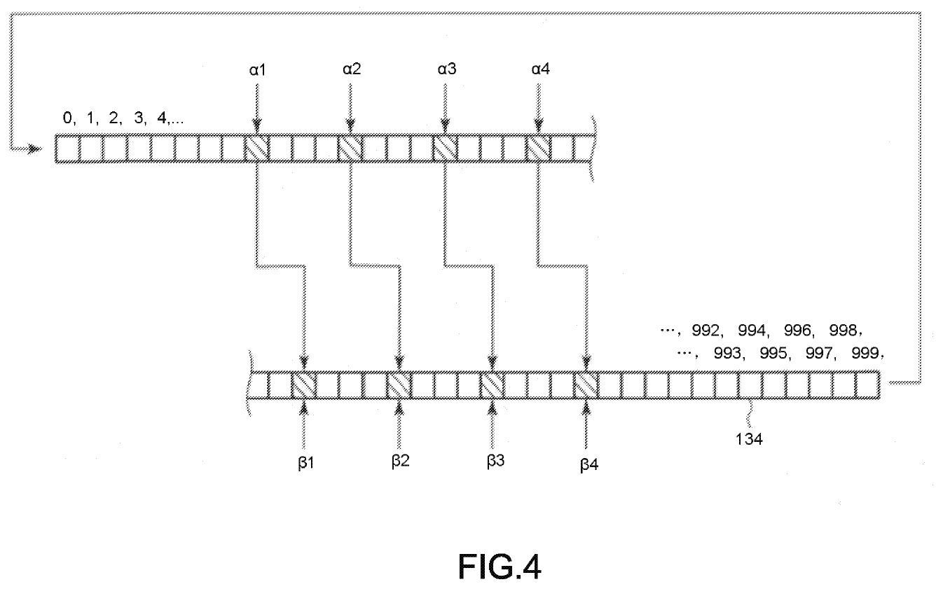

FIG. 4 is a diagram illustrating an example of the operation of the control board 130.

First, the counter 134 counts the count value from “0” to “999” at the predetermined interval. The counter 134 returns the count value to “0” if the count value is counted up from a state in which the count value is “999”.

The comparators 201 to 204 stands by until the transmission start signal from the detection section 110 or the control board 30 is received via the communication section 131. Herein, at the time point at which the count values by the counter 134 are α1 to α4, the transmission start signal is input to the communication section 131.

At the time point at which the count value by the counter 134 is α1, any comparator of the comparators 201 to 204 receives the transmission start signal. It is assumed that the comparator 201 receives the transmission start signal.

The comparator 201 sets a comparative value obtained by adding the count value (α1) to the offset value (OF) if the transmission start signal is received. In other words, the comparator 201 sets α1+OF (β1) as the comparative value therein.

At the time point at which the count value by the counter 134 is α2, any comparator of the comparators 202 to 204 receives the transmission start signal. It is assumed that the comparator 202 receives the transmission start signal.

The comparator 202 sets a comparative value obtained by adding the count value (α2) to the offset value (OF) if the transmission start signal is received. In other words, the comparator 202 sets α2+OF (β2) as the comparative value therein.

Similarly, the comparator 203 sets α3+OF (β3) as the comparative value therein at the time point at which the count value by the counter 134 is α3. The comparator 204 sets α4+OF (β4) as the comparative value therein at the time point at which the count value by the counter 134 is α4.

The comparators 201 to 204 stand by until the count values by the counter 134 respectively become β1 to β4. In other words, the comparators 201 to 204 determine whether or not the count values by the counter 134 respectively become the comparative values (β1 to β4).

If the count value by the counter 134 becomes β1, the comparator 201 sends the transmission start signal to the head drive signal generation circuit 135. At the same time, the comparator 201 sends the transmission start signal to the control board 130 of the next stage via the communication section 132.

The comparator 201 resets the comparative value set therein if the transmission start signal is sent to the printing section 140 and the control board 130 of the next stage. The comparator 201 stands by until a next transmission start signal is received.

The head drive signal generation circuit 135 receives the transmission start signal from the comparator 201. The head drive signal generation circuit 135 sends the head drive signal to the printing section 140 via the communication section 133 if the transmission start signal is received.

If the count value by the counter 134 becomes β2, the comparator 202 sends the transmission start signal to the head drive signal generation circuit 135. At the same time, the comparator 202 sends the transmission start signal to the control board 130 of the next stage via the communication section 132.

The comparator 202 resets the comparative value set therein if the transmission start signal is sent to the printing section 140 and the control board 130 of the next stage. The comparator 202 stands by until the next transmission start signal is received.

The head drive signal generation circuit 135 receives the transmission start signal from the comparator 202. The head drive signal generation circuit 135 sends the head drive signal to the printing section 140 via the communication section 133 if the transmission start signal is received.

Similarly, if the count value by the counter 134 becomes β3, the comparator 203 sends the transmission start signal to the control board 130 of the next stage via the communication section 132. The comparator 203 sends the transmission start signal to the head drive signal generation circuit 135. The comparator 203 resets the comparative value set therein and stands by until the next transmission start signal is received. The head drive signal generation circuit 135 sends the head drive signal to the printing section 140 via the communication section 133 if the transmission start signal is received from the comparator 203.

Similarly, if the count value by the counter 134 becomes β4, the comparator 204 sends the transmission start signal to the control board 130 of the next stage via the communication section 132. The comparator 204 sends the transmission start signal to the head drive signal generation circuit 135. The comparator 204 resets the comparative value set therein and stands by until the next transmission start signal is received. The head drive signal generation circuit 135 sends the head drive signal to the printing section 140 via the communication section 133 if the transmission start signal is received from the comparator 204.

The control board 130 sends the transmission start signal to the control board 130 of the next stage and sends the head drive signal to the printing section 140 by repeating the above operation.

Next, an example of the operation of the inkjet printer 1 is described.

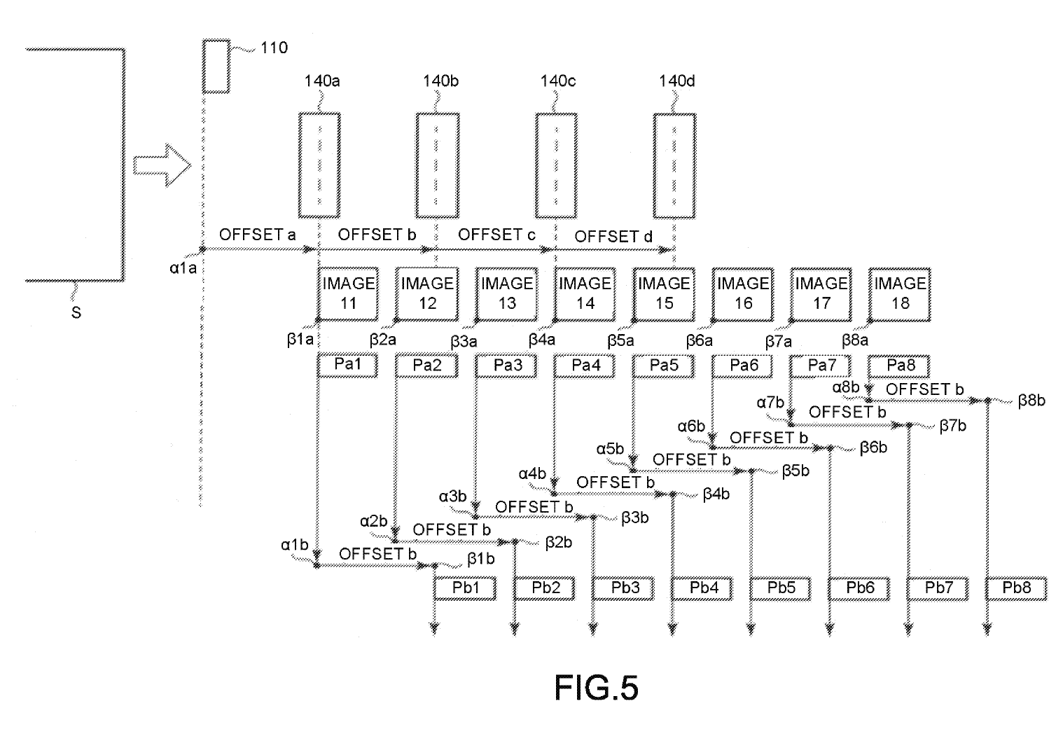

FIG. 5 is a diagram illustrating an example of the operation of the inkjet printer 1.

The example of the operation is described by using the inkjet heads 300a to 300d. The inkjet printer 1 forms images 11 to 18 on the print medium S. The images 11 to 18 are formed by ejecting the ink to the same area by the inkjet heads 300a to 300d. The width of each of the images 11 to 18 is smaller than the distance between the printing sections 140 of the inkjet heads 300. The print medium movement section 70 conveys the print medium S at a predetermined speed in the order of the printing section 140a, the printing section 140b, the printing section 140c and the printing section 140d.

The detection section 110 detects that the print medium S is conveyed to a predetermined printing start position (printing start position for printing the image 11). If it is detected that the print medium S is conveyed to the predetermined printing start position, the detection section 110 sends the transmission start signal to the control board 130a of the inkjet head 300a.

The comparator 201a of the control board 130a receives the transmission start signal via the communication section 131a. If the transmission start signal is received, the comparator 201a sets a value obtained by adding the offset value a (OFa) to the count value (α1a) by the counter 134 as the comparative value (β1a) therein.

The detection section 110 detects that the print medium S is conveyed to the predetermined printing start position (printing start position for printing the image 12). If it is detected that the print medium S is conveyed to the predetermined printing start position, the detection section 110 sends the transmission start signal to the control board 130a of the inkjet head 300a.

The comparator 202a of the control board 130a receives the transmission start signal via the communication section 131. If the transmission start signal is received, the comparator 202a sets a value obtained by adding the offset value a (OFa) to the count value (α2a) by the counter 134 as the comparative value (β2a) therein.

If the count value by the counter 134 becomes β1a, the comparator 201a sends the transmission start signal to the head drive signal generation circuit 135. The head drive signal generation circuit 135 sends the head drive signal to the printing section 140a via the communication section 133a if the transmission start signal and the image data are received. The printing section 140a receives the head drive signal. If the head drive signal is received, the printing section 140a prints the image 11 on the print medium S based on the head drive signal. In other words, the printing section 140a continues printing in a required period (Pa1) form the image 11 from a moment the transmission start signal is received.

The comparator 201a sends the transmission start signal to the control board 130b of the inkjet head 300b via the communication section 132a while sending the transmission start signal to the head drive signal generation circuit 135.

If the count value by the counter 134 becomes β2a, the comparator 202a sends the transmission start signal to the head drive signal generation circuit 135. The head drive signal generation circuit 135 sends the head drive signal to the printing section 140a via the communication section 133a if the transmission start signal and the image data are received. The printing section 140a receives the head drive signal. If the head drive signal is received, the printing section 140a prints the image 12 on the print medium S based on the head drive signal. In other words, the printing section 140a continues printing in a required period (Pa2) to form the image 12 from a moment the transmission start signal is received.

The comparator 202a sends the transmission start signal to the control board 130b of the inkjet head 300b via the communication section 132a while sending the transmission start signal to the head drive signal generation circuit 135.

Further, while the counter 134 counts up the count value from β1a to β1b, the detection section 110 may detect that the print medium S is conveyed to the predetermined printing start position (the predetermined printing start position for printing the image 13). If the print medium S is conveyed to the printing start position, the detection section 110 sends the transmission start signal to the control board 130a.

The comparator 201a of the control board 130a may receive the transmission start signal to set the comparative value. The comparator 203a of the control, board 130a may receive the transmission start signal to set the comparative value. If there is the comparator which does not set the comparative value, any one of the comparators may receive the transmission start signal to set the comparative value.

Hereinafter, the inkjet head 300a forms the images 13 to 18 by operating in the same way as stated above.

An example of the operation of the inkjet head 300b is described.

If the count value by the counter 134 becomes β1a, the comparator 201b of the control board 130b receives the transmission start signal from the control board 130a via the communication section 131b. If the transmission start signal is received, the comparator 201b sets the value obtained by adding an offset value b (OFb) to the count value by the counter 134 (β1a, in other words, α1b) as the comparative value (β1b) therein.

If the count value by the counter 134 becomes β2a, the comparator 201b of the control board 130b receives the transmission start signal from the control board 130a via the communication section 131b. If the transmission start signal is received, the comparator 202b sets the value obtained by adding the offset value b (OFb) to the count value by the counter 134 (β2a, in other words, α2b) and sets the value as the comparative value (β2b) therein.

If the count value by the counter 134 becomes β1b, the comparator 201b sends the transmission start signal to the head drive signal generation circuit 135. The head drive signal generation circuit 135 sends the head drive signal to the printing section 140b via the communication section 133b if the transmission start signal is received. The printing section 140b receives the head drive signal. If the head drive signal is received, the printing section 140b prints the image 11 on the print medium S based on the head drive signal. In other words, the printing section 140b continues printing in a required period (Pb1) to form the image 11 from a moment the transmission start signal is received.

The comparator 201b sends the transmission start signal to the control board 130c of the inkjet head 300c via the communication section 132b while sending the transmission start signal to the printing section 140b.

If the count value by the counter 134 becomes β2b, the comparator 202b sends the transmission start signal to the head drive signal generation circuit 135. The head drive signal generation circuit 135 sends the head drive signal to the printing section 140b via the communication section 133b if the transmission start signal is received. The printing section 140b receives the head drive signal. If the head drive signal is received, the printing section 140b prints the image 12 on the print medium S based on the head drive signal. In other words, the printing section 140b continues printing in a required period (Pb2) to form the image 12 from a moment the transmission start signal is received.

The comparator 202b sends the transmission start signal to the control board 130c of the inkjet head 300c via the communication section 132b while sending the transmission start signal to the head drive signal generation circuit 135.

Further, while the counter 134 counts up the count value from β1b to β1b the control board 130b may receive the transmission start signal from the control board 130a.

Hereinafter, the inkjet head 300b forms the images 13 to 18 by operating in the same way as stated above.

The inkjet head 300c and 300d form the images 11 to 18 by operating in the same way as stated above.

Further, in a case in which the number of the images formed between the printing sections 140 is larger than that of the comparators located in the control board 130, the inkjet printer 1 may combine a plurality of images into one image.

The inkjet head with the constitution as stated above receives the transmission start signal at the printing start time point of the inkjet head of the upper stage. The inkjet head sets the comparative value obtained by adding the predetermined offset value to the count value by the counter in the comparator if the transmission start signal is received. The inkjet head starts the printing if the count value by the counter reaches the comparative value. The inkjet head transmits the transmission start signal to the inkjet head of the next stage. The inkjet printer is provided with a plurality of the comparators and can set the comparative value in each comparator.

As a result, even if the next transmission start signal is received before the printing is started after the transmission start signal is received, the inkjet head can set the comparative value corresponding to the transmission start signal. Therefore, the inkjet head can start the printing at a desired timing according to each transmission start signal.

Therefore, even when there is a plurality of print images between the printing sections of the inkjet head, the inkjet head can print each print image at a desired timing.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An inkjet head, comprising:
a counter configured to count a count value at a predetermined interval;
a plurality of comparators configured to set a comparative value obtained from the count value and an offset value if a first transmission start signal is input from a first device, and configured to output a second transmission start signal to a second device if the count value becomes a comparative value;
a head drive signal generation section configured to output a head drive signal if the second transmission start signal is output; and
a head main body configured to eject ink to a print medium if the head drive signal is output.

2. The inkjet head according to claim 1, wherein
in a direction in which the print medium moves, a width of an image formed by ejecting the ink by the head main body is smaller than a distance between the head main body and a head main body of another inkjet adjacent thereto.

3. The inkjet head according to claim 1, wherein
the second device is a control board of a lower stage.

4. The inkjet head according to claim 2, wherein
the second device is a control board of a lower stage.

5. The inkjet head according to claim 1, wherein
the first device is a control board of an upper stage, and
the offset value corresponds to a time required to convey the print medium by a distance between the head main body and the head main body of the another inkjet adjacent thereto.

6. The inkjet head according to claim 1, wherein
the first device is a detection section for detecting that the print medium is conveyed to a predetermined position, and
the offset value corresponds to a time required to convey the print medium by a distance between the predetermined position and a position where the head main body forms an image.

7. An inkjet printer, comprising:
a conveyance section configured to convey a print medium, and
a plurality of inkjet heads according to claim 1 in which printing sections are arranged in order in a conveyance direction.

8. The inkjet printer according to claim 7, wherein
in a direction in which the print medium moves, a width of an image formed by ejecting the ink by the head main body is smaller than a distance between the head main body and a head main body of another inkjet adjacent thereto.

9. The inkjet printer according to claim 7, wherein
the second device is a control board of a lower stage.

10. The inkjet printer according to claim 7, further comprising:
a plurality of ink cartridges.

11. The inkjet printer according to claim 7, further comprising:
at least one of an ink cartridge comprising black ink, an ink cartridge comprising cyan ink, an ink cartridge comprising yellow ink, and an ink cartridge comprising magenta ink.

12. An inkjet method, comprising:
counting a count value at a predetermined interval;
configured to setting a comparative value obtained from the count value using a plurality of comparators and an offset value if a first transmission start signal is input from a first device;
outputting a second transmission start signal to a second device if the count value becomes a comparative value;
outputting a head drive signal if the second transmission start signal is output; and
ejecting ink to a print medium if the head drive signal is output.

13. The inkjet method according to claim 12, wherein
in a direction in which the print medium moves, a width of an image formed by ejecting the ink is smaller than a distance between a head main body and a head main body of another inkjet adjacent thereto.

14. The inkjet method according to claim 12, wherein
the second device is a control board of a lower stage.

15. The inkjet method according to claim 13, wherein
the second device is a control board of a lower stage.

16. The inkjet method according to claim 12, wherein
the first device is a control board of an upper stage, and
the offset value corresponds to a time required to convey the print medium by a distance between a head main body and a head main body of another inkjet adjacent thereto.

17. The inkjet method according to claim 12, further comprising:
detecting that the print medium is conveyed to a predetermined position; and
conveying the print medium by a distance between the predetermined position and a position where the head main body forms an image.

18. The inkjet method according to claim 12, further comprising:
ejecting ink from a plurality of ink cartridges.

19. The inkjet method according to claim 12, further comprising:
ejecting ink from at least one of an ink cartridge comprising black ink, an ink cartridge comprising cyan ink, an ink cartridge comprising yellow ink, and an ink cartridge comprising magenta ink.
